(19) United States
(12) Patent Application Publication
(10) Pub. No.: US 2018/0247395 A1
(43) Pub. Date: Aug. 30, 2018

(54) CELL OBSERVATION APPARATUS

(71) Applicant: Shimadzu Corporation, Kyoto (JP)

(72) Inventors: Yusuke AOI, Kyotanabe-shi (JP); Yoshihiko IWAO, Kyoto-shi (JP)

(73) Assignee: Shimadzu Corporation, Kyoto (JP)

(21) Appl. No.: 15/906,379

(22) Filed: Feb. 27, 2018

(30) Foreign Application Priority Data
Feb. 28, 2017 (JP) 2017-035799

(51) Int. Cl. G06T 5/00; G06T 5/40; G06T 11/00; G02B 21/36

(52) U.S. Cl. CPC G06T 5/007; G06T 5/40; G06T 2207/10056; G02B 21/368; G02B 21/365; G06T 11/001

(57) ABSTRACT

A display image formation unit reads image data according to a designated condition from an image data storage unit to form a phase image, a drawing color setting unit colorizes a phase image according to a color scale in which a phase value in the vicinity of 0 is associated with black, a phase value in a positive direction is associated with a predetermined color other than black, and a phase value in a negative direction is associated with another color other than black. In an area where no cell exists on a medium, the phase value becomes almost 0, so that the background area of the cell on the colorized phase image becomes almost black and the cell is depicted in a color other than black.

### FIELD

The present invention relates to a cell observation apparatus for observing biological cells, and more particularly, to a cell observation apparatus for observing biological cells using a phase contrast microscopic image obtained by a phase contrast microscope, a phase image created on the basis of a hologram by a digital holographic microscope, and the like.

### BACKGROUND ART

In the field of regenerative medicine, studies using pluripotent stem cells such as iPS cells and ES cells have been actively conducted in recent years. In general, biological cells are colorless and transparent and difficult to observe with a normal optical microscope. Therefore, a phase contrast microscope is widely used to observe biological cells (see, Patent Literature 1 and the like). For the phase contrast microscope, when illumination light passes through an observation target, a two-dimensional observation image can be created with contrast of light and dark, on the basis of a difference between an optical path of light diffracted by the object and an optical path of direct light of the illumination. The observation image may be conventionally called a phase contrast image. However, strictly speaking, the observation image also includes an element of an intensity, so the observation image will be referred to as a phase contrast microscopic image in the present disclosure.

Meanwhile, recently, an apparatus has been developed that acquires phase information of light by using holography technology, and creates a phase image and an intensity image of the observation target on the basis of the information. The apparatus is referred to as a holographic microscope or a digital holographic microscope (see Patent Literature 2 and the like).

In the holographic microscope, an interference fringe (hologram) is obtained which is formed on a detection surface of an image sensor or the like by object light that comes from a light source and is reflected from or transmitted through a surface of the observation target and reference light that directly reaches from the light source, and a two-dimensional phase image or an intensity image is obtained as a reproduction image of the observation target by executing a predetermined arithmetic processing based on the hologram.

When cells in culture are observed on a cell culture plate, a phase delay or a phase advance of diffracted light or object light does not occur in an area where the cells are not present, so that a phase value or a phase contrast value becomes almost zero in an area where cells are not present in a phase image or a phase contrast microscopic image, that is, in a background area. For example, when a phase image is displayed in accordance with a gray scale, an image showing a spatial distribution of phase values is created by associating a phase value of each pixel in the phase image with a plurality of gradations between black and white, and the pertinent image is displayed on a screen of a display unit. Usually, the phase value (phase contrast) of zero is associated with a gray color just between the white and the black because the phase value assumes positive and negative polarity values.

However, as described above, since a phase value of the background area where no cells are present is almost zero, this background area is drawn in an intermediate gray color. For this reason, a contrast between a cell part to be observed and a background part is difficult to obtain and clarity of an outline of the cell, a pattern inside the cell and the like is low, hindering the observation.

[Patent Literature 1] JP-A-2015-152650

[Patent Literature 2] International Patent Publication No. 2016/084420

[Patent Literature 3] JP-A-10-268740

### SUMMARY

The present invention has been made in view of the above-described problems, and it is an object of the present invention to provide a cell observation apparatus capable of improving a visibility of cells and improving an accuracy of observation when observing the cells with a phase image, a phase contrast microscopic image and the like.

The present invention made to solve the above problems is a cell observation apparatus using a holographic microscope or a phase contrast microscope, including:

a) an image creation unit that creates an image showing a spatial distribution of phase information or information corresponding thereto on the basis of data obtained by the holographic microscope or the phase contrast microscope;

b) a drawing color setting unit that associates black with a phase value of zero, and gives a display color to each pixel on the image created by the image creation unit in accordance with a color scale associating a phase value which is a positive value and a phase value which is a negative value with different colors other than black respectively; and

c) a display processing unit that displays on a display unit an image with the display color given by the drawing color setting unit.

Here, when a phase contrast microscope is used in the cell observation apparatus according to the present invention, the phase information or the information corresponding thereto is a phase difference, and the phase value is a phase difference value. Further, when a holographic microscope is used in the cell observation apparatus according to the present invention, the phase information or the information corresponding thereto may be, in addition to the phase, a pseudo phase (corresponding to a phase difference in the phase contrast microscope) or an optical path length difference and the like, and the phase value may be a pseudo phase value or an optical path length difference value.

Further, in the cell observation apparatus according to the present invention, colors associated with the phase value that is positive value and the phase value that is negative value respectively are not particularly limited but may be, for example, blue and green, red and green, and the like.

When the present invention is a cell observation apparatus using a holographic microscope, since a spatial distribution of phase information can be obtained by a predetermined arithmetic processing based on hologram data obtained by the holographic microscope, the image creation unit associates the phase information with each pixel of a two-dimensional image, thereby creating a phase image showing a two-dimensional distribution of the phase value. The drawing color setting unit colorizes the image by giving the display color to each pixel on the image created according to a color scale. At that time, a color scale is used in which black is associated with the phase value of zero, and the phase value which is a positive value and the phase value which is a negative value are associated with different colors except black respectively. The display processing unit displays the colored image on the screen of the display unit.

When the observation object is a living cell in the cell culture plate, a color of an image of a background area of the living cell, that is, a culture medium is almost black. On the other hand, since a cell area in which the cell exists exhibits a positive or negative phase value, the cell area is displayed in a color different from black, for example, green or blue, or an intermediate color between them and black. As a result, an outline of the cell, that is, a boundary between the cell and the background or a pattern inside the cell is clearly displayed.

Preferably, the cell observation apparatus according to the present invention may be configured to further include:

an adjustment operation unit that allows a user to adjust brightness and/or contrast of an image displayed on the display unit; and

an image parameter adjustment unit that adjusts the brightness and/or contrast of the image to be displayed, according to an operation by the adjustment operation unit.

In the above configuration, when an operator appropriately adjusts the brightness and the contrast of the phase image to be displayed by the adjustment operation unit, the image parameter adjustment unit, according to the operation, adjusts the brightness and the contrast of the phase image independently of a type or a density of color of the image. Therefore, the operator can adjust the brightness and the contrast appropriately so that the cell to be observed may be easily seen.

Preferably, the cell observation apparatus according to the present invention may be configured to further include a change operation unit that allows the user to change a correspondence between a range of the phase value in the color scale and the display color or its density, in which the drawing color setting unit changes the display color to be given to each pixel on the image according to an operation by the change operation unit.

According to above configuration, for example, even in a case where there are many phase values relatively close to zero or a difference in phase values of the entire image is small, it is possible to visually clarify a small difference in phase values by changing a correspondence between a range of the phase value and a density of the display color appropriately. Asa result, it is possible to further improve a visibility of the pattern inside the cell or the like.

Preferably, in the cell observation apparatus according to the present invention, the drawing color setting unit may be configured to give the display color to each pixel on the image created by the image creating unit, in accordance with an arbitrary color scale selected from a plurality of previously prepared color scales in addition to the color scale.

According to the above configuration, for example, in the case of displaying in accordance with a default color scale, when a visibility of the cell to be observed is not good, the operator changes the color scale appropriately to improve the visibility.

Further, the cell observation apparatus according to the present invention may be configured to further include a contrast adjustment unit that adjusts the contrast of the image automatically.

According to the above configuration, it is possible to adjust the contrast of the phase image colored in accordance with the default color scale or the color scale set by the operator to be optimized without the operator's manual adjustment of the contrast. As a result, it is possible to efficiently observe the cells by eliminating a labor of the operator.

According to the cell observation apparatus according to the present invention, in particular, a boundary between the cell to be observed and its background portion becomes clear, thereby making it easy for the operator to grasp a size or a shape of the cell easily. As a result, for example, when determining whether the cell is a single cell or a cell colony on the basis of a size and a shape of the cell, the determination can be performed quickly and accurately.

### BRIEF DESCRIPTION OF THE DRAWINGS

FIG. 1 is a schematic configuration diagram of a cell observation apparatus according to an embodiment of the present invention;

FIG. 2 is a schematic diagram illustrating an example of correspondence between a phase value and a display color at the time of displaying a phase image in the cell observation apparatus of the present embodiment;

FIG. 3 is a schematic diagram of an image display screen in the cell observation apparatus of the present embodiment; and

FIG. 4 is a diagram illustrating a comparison between (a) a phase image according to a general grayscale display and (b) a phase image by color display in the cell observation apparatus according to the present embodiment.

### DETAILED DESCRIPTION

Hereinafter, an embodiment of a cell observation apparatus according to the present invention will be described with reference to the accompanying drawings.

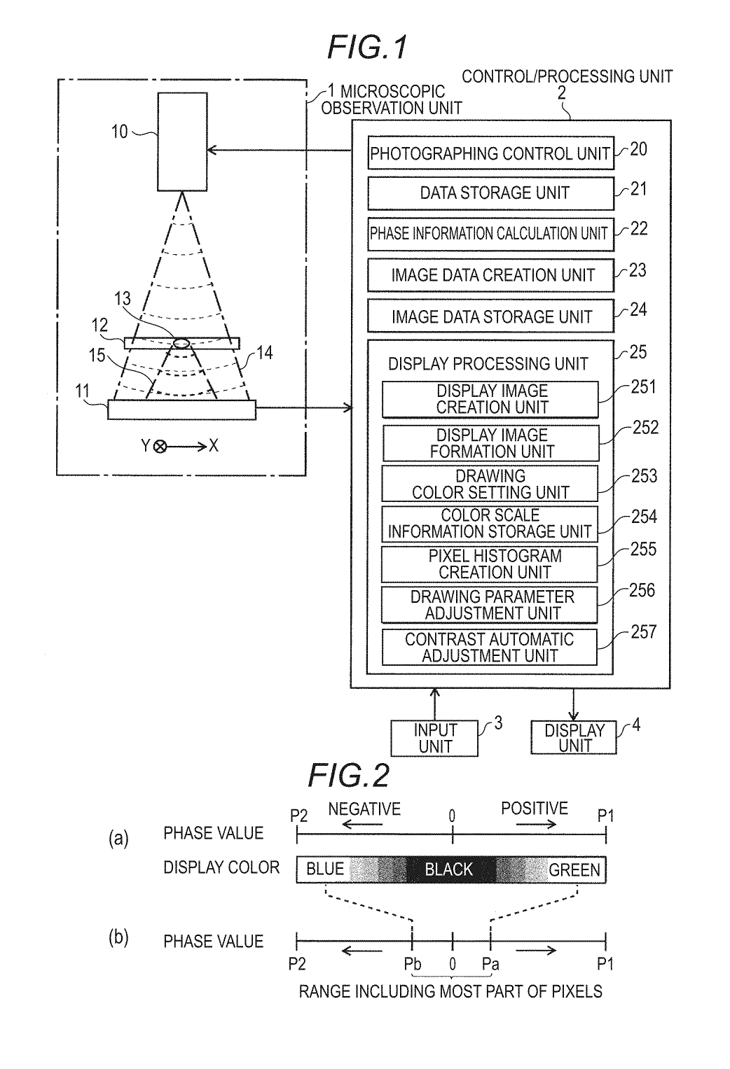

FIG. 1 is a schematic configuration diagram of the cell observation apparatus according to the present embodiment.

The cell observation apparatus according to the present embodiment includes a microscopic observation unit 1, a control/processing unit 2, an input unit 3 and a display unit 4 as a user interface.

The microscopic observation unit 1 is an in-line holographic microscope (IHM), and includes a light source unit 10 including a laser diode and the like and an image sensor 11, and a cell culture plate 12 containing a cell 13 to be observed is placed between the light source unit 10 and the image sensor 11.

The control/processing unit 2 controls an operation of the microscopic observation unit 1 and processes the data acquired by the microscopic observation unit 1, and includes a photographing control unit 20, a data storage unit 21, a phase information calculation unit 22, an image data creation unit 23, an image data storage unit 24, and a display processing unit 25 as functional blocks. The display processing unit 25 includes a display screen creation unit 251, a display image formation unit 252, a drawing color setting unit 253, a color scale information storage unit 254, a pixel histogram creation unit 255, a drawing parameter adjustment unit 256, and a contrast automatic adjustment unit 257 as lower functional blocks.

An entity of the control/processing unit 2 is a personal computer or a higher-performance workstation, and the functions of the functional blocks may be realized by operating dedicated control/processing software installed in such a computer on the computer. Further, as will be described later, a function of the control/processing unit 2 may be shared by a plurality of computers connected via a communication network instead of a single computer.

In the cell observation apparatus of the present embodiment, an observation image of the cell to be observed is formed in the following manner.

First, an operator sets the cell culture plate 12 including the cell (pluripotent cell) 13 to be analyzed at a predetermined position, and inputs information, such as an identification number and measurement date and time, specifying the cell culture plate from the input unit 3. Then, an execution of measurement is instructed. Upon receiving the instruction, the photographing control unit 20 controls the microscopic observation unit 1 to acquire data as described below.

That is, under the control of the photographing control unit 20, the light source unit 10 irradiates a predetermined area of the cell culture plate 12 with coherent light having a spread of a small angle of about 10 degrees. The coherent light (object light 15) which passed through the cell culture plate 12 and the cell 13 reaches the image sensor 11 while interfering with light (reference light 14) which passed through an area close to the cell 13 on the cell culture plate 12. The object light 15 is a light whose phase has changed when it passes through the cell 13, while the reference light 14 is not subjected to the phase change caused by the cell 13 since it does not pass through the cell 13. Therefore, an interference image (hologram) of the object light 15 whose phase has been changed by the cell 13 and the reference light 14 whose phase is not changed is formed on a detection surface (an image plane) of the image sensor 11.

The cell culture plate 12 is sequentially moved in two axial directions of the X axis and the Y axis (in a plane perpendicular to the paper surface of FIG. 1) by a moving mechanism (not illustrated). Thus, by moving an irradiation area (an observation area) of the coherent light emitted from the light source unit 10 stepwise on the cell culture plate 12, hologram for each small area within a wide observation area is repeatedly acquired and hologram data for the entire observation area can be collected.

As described above, the hologram data (two-dimensional light intensity distribution data of the hologram formed on the detection surface of the image sensor 11) obtained by the microscopic observation unit 1 are sequentially sent to the control/processing unit 2, and stored in the data storage unit 21. In the control/processing unit 2, the phase information calculation unit 22 reads out the hologram data for each of the small areas from the data storage unit 21 and calculates phase information reflecting an optical thickness of the cell 13 by executing a predetermined arithmetic processing. Based on phase information calculated for each hologram, the image data creation unit 23 obtains image data for forming a phase image of the entire observation area, and stores the image data, together with attribute information such as photographing date and time and an identification number of the cell culture plate, in the image data storage unit 24. When calculating such phase information and creating the phase image, well-known algorithms disclosed in Patent Literatures 2, 3 and the like may be used. In addition to the phase information, intensity information, pseudo phase information and the like may also be calculated on the basis of the hologram data, and a reproduced image may be generated on the basis of the information.

The cell observation apparatus according to the present embodiment is characterized by the display processing when the phase image based on the image data created as described above is displayed on the screen of the display unit 4. The process will be described with reference to FIGS. 2 to 4 in addition to FIG. 1.

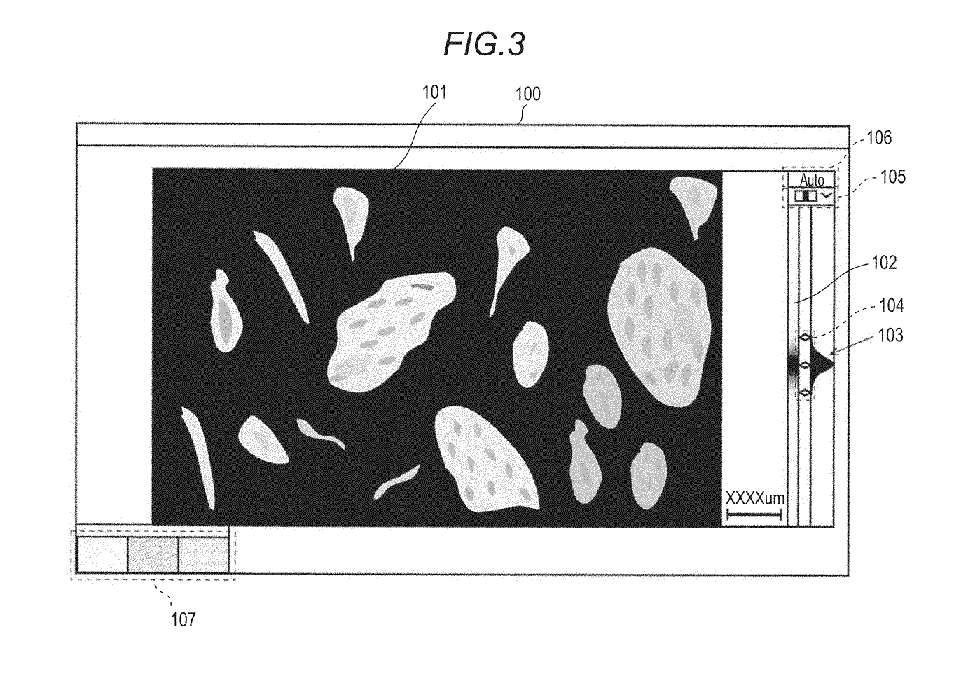

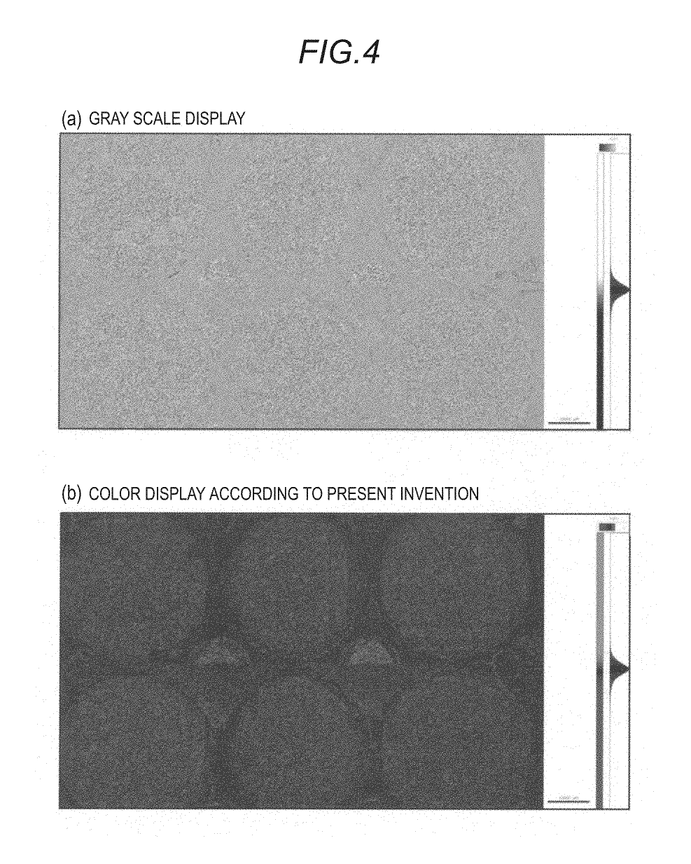

FIG. 2 is a schematic diagram illustrating an example of correspondence between the phase value and the display color in the cell observation apparatus according to the present embodiment, FIG. 3 is a schematic diagram of an image display screen in the cell observation apparatus according to the present embodiment, and FIG. 4 is a diagram illustrating a comparison between (a) a phase image by general gray scale display and (b) a phase image of color display by the cell observation apparatus according to the present embodiment.

When the operator desires to observe the phase image of the cell on the cell culture plate 12 photographed by the microscopic observation unit 1, the operator performs a predetermined operation including designation of conditions such as acquisition date and time of the image to be observed, identification number of the cell culture plate from the input unit 3. In response to the operation, the display image formation unit 252 reads data corresponding to the designated condition from the image data storage unit 24. The data at this time is, for example, a two-dimensional distribution of the entire observation area or a partial phase value. Then, a phase image is formed by placing each phase value at a position corresponding to each pixel of the two-dimensional display image.

On the other hand, the display screen creation unit 251 displays an image display screen 100 as illustrated in FIG. 3 on the screen of the display unit 4. As illustrated in FIG. 3, an image display area 101 occupying a large area is arranged in the center of the image display screen 100 and, on the right side of the image display area 101, a color scale bar display field 102 and a histogram display field 103 which extend in the vertical direction are arranged. A color scale selection unit 105 and an automatic contrast adjustment instruction unit 106 are arranged on the upper side of the color scale bar display field 102 and the histogram display field 103. Further, on the lower left side of the image display screen 100 is provided a thumbnail image display field 107 of a reproduced image which can be selectively displayed.

When the phase image is formed by the display image formation unit 252, the drawing color setting unit 253 creates a color image by assigning the display color corresponding to the phase value at each pixel of the phase image to the pixel according to one of the plurality of color scales stored in the color scale information storage unit 254. At this time, the color scale to be used by default is a three-color scale in which the phase value of 0 is black, one color other than black (here, green) corresponds to a positive phase value, and another color (Here, blue) corresponds to a negative phase value.

That is, as illustrated in FIG. 2(a), the phase value may take a value in the range between a positive maximum value P1 and a negative maximum value P2. Therefore, a predetermined phase value range including the phase value of 0 is designated as pure black, a predetermined phase value range including the phase value P1 is designated as pure green, and a predetermined phase value range including the phase value P2 is designated as pure blue, and a relationship between the display color and the phase value is set so that a color obtained by gradually mixing black and green is designated in the phase value 0 to P1 and the color obtained by gradually mixing black and blue is designated in the phase value 0 to P2. In an area where no cells exist on the medium in the cell culture plate 12, that is, the background area, the phase value becomes 0 or nearly 0. Therefore, the display color of the background area is approximately black. On the other hand, since the phase value corresponds to an optical thickness of the cell or refractive index in the cell and the like in the area where cells exist on the medium, the area is colored with a color of green, blue or a color obtained by mixing them with black, other than pure black.

The display screen creation unit 251 displays thus colorized phase image in the image display area 101 in the image display screen 100. In addition, the color scale used for colorization is displayed in the color scale bar display field 102.

The pixel histogram creation unit 255 creates a histogram illustrating a frequency for each predetermined phase value range for all the phase values in the phase image to be displayed, and the display screen creation unit 251 displays the created histogram in the histogram display field 103.

Further, a slider 104 indicated by three rhombic symbols on upper and lower sides is displayed between the color scale bar display field 102 and the histogram display field 103. One of the rhombic symbols (one positioned at the center in FIG. 3) indicates a pure black display color with a phase value of 0, and the other two indicate an upper limit and a lower limit of a range in which the frequency falls within a predetermined ratio (for example, 95%) of the whole on the histogram respectively. An adjustment using the slider 104 will be described later.

Incidentally, when a plurality of conditions, for example, a plurality of photographing dates and times are designated to instruct display of the phase image in order to compare a plurality of phase images, thumbnail images of the phase image respectively corresponding to the plurality of conditions are displayed in the thumbnail image display field 107. When the operator instructs to select the thumbnail image displayed in the thumbnail image display field 107 with a pointing device or the like included in the input unit 3 appropriately, the phase image displayed in the image display area 101 can be replaced.

### [Adjustment of Contrast on a Fixed Color Scale]

As illustrated in FIG. 2(a), display colors are normally assigned so as to correspond to the entire range (a range of P1 to P2) of the phase value in the phase image to be displayed, but in many cases, the phase values at the time of cell observation are concentrated in the range close to 0, and values close to the phase values P1 and P2 are taken rarely. Therefore, if a display color is proportionally assigned so as to correspond to the entire range of the phase value, the entire phase image becomes a display color close to black and it is difficult to improve the visibility of the cell. Therefore, in the cell observation apparatus of the present embodiment, as illustrated in FIG. 2(b), correspondence between the phase value and the display color may be adjusted so that a range of the phase value (a range of Pa to Pb) including the most part of the pixels forming the phase image is associated with the most part of the entire color scale. Further, when the operator himself operates the aforementioned slider 104 with the input unit 3, the correspondence between the phase value and the display color can be manually adjusted appropriately.

As illustrated in FIG. 2(b), when the phase value and the display color are associated with each other, a slight difference in phase value appears as a difference in the display color on the display image. For this reason, for example, fine patterns in the cell are easily depicted as a difference in display color, and the visibility of the cells is improved. Further, the boundary between the background area and the cell becomes clearer. As described above, the two symbols in the slider 104 correspond to the upper limit and the lower limit of the range in which the frequency falls within the predetermined percentage of the whole on the histogram. When the operator appropriately shifts them upwardly or downwardly, the display colors corresponding to the upper limit and the lower limit on the histogram respectively change. Thereby, it is possible to adjust the correspondence between the display color and the phase value so that the operator can obtain the most easily viewable contrast according to a distribution state of the phase value in the phase image to be observed at that time.

As described above, a contrast adjustment for improving a visibility of the image may be performed automatically instead of being manually performed by the operator. In other words, when an automatic adjustment of the contrast of the display image is desired, the operator clicks the automatic contrast adjustment instruction unit 106 with the pointing device. Then, the contrast automatic adjustment unit 257 automatically adjusts the contrast of the displayed phase image according to a predetermined algorithm.

FIG. 4 illustrates a case in which the same phase image is displayed according to a general gray scale and a case in which the phase image is displayed in color according to the aforementioned characteristic process of the present embodiment. It can be seen that the outline of the cell and the pattern inside thereof difficult to see in FIG. 4(a) can be clearly confirmed in FIG. 4(b).

### [Change in Color Scale]

When it is desired to change the color scale set at that time to another color scale, the operator clicks the color scale selection unit 105 with the pointing device. Then, the drawing color setting unit 253 displays a list of various color scale patterns stored in advance in the color scale information storage unit 254 in a pull-down menu. The operator selects a desired color scale from the pull-down menu by clicking. In response to the color scale selection operation, the display screen creation unit 251 changes the color scale displayed in the color scale bar display field 102 according to the setting. Further, the drawing color setting unit 253 changes the display color for each pixel of the displayed phase image according to the newly selected color scale. Accordingly, the color of the phase image being displayed is changed. Of course, the color scale may be created by the operator.

### [Manual Adjustment of Brightness of Display Image]

When it is desired to adjust brightness of the displayed phase image, if the operator performs a predetermined operation, the display screen creation unit 251 displays a dialog for adjusting the image parameter on the screen. In the dialog on the screen, a slider for brightness adjustment and a numeric value input box are provided. The operator operates the slider appropriately or inputs an appropriate numerical value to the numerical value input box directly. In response to such an adjustment operation, the drawing parameter adjustment unit 256 changes the brightness of the phase image displayed in the image display area 101. Thereby, the visibility of the display image can be further improved.

In the above description, blue and green are used as the display colors other than black of the color scale, but they may be arbitrary colors. Of course, a color with a clear contrast with black and a clear contrast between the two colors other than black is preferable. For example, green and red, blue and red, and the like may be used.

Further, in the configuration of the embodiment illustrated in FIG. 1, all the processes are executed in the control/processing unit 2, but in general, an enormous amount of calculation is necessary for calculating the phase information based on the hologram data and imaging a result of the calculation. Therefore, it takes a lot of time to calculate in a personal computer usually used, and it is difficult to perform an efficient analysis work. Therefore, a computer system may be used in which a personal computer connected to the microscopic observation unit 1 is a terminal device, and the terminal device and a server which is a high-performance computer are connected via a communication network such as the Internet or an intranet. In this case, complicated processing such as calculation of phase information based on hologram data and creation of the phase image may be performed on the server. Upon receiving the image data created by the server, the terminal device may form and display the phase image on the basis of the image data. In such a configuration, the functional blocks of the control/processing unit 2 illustrated in FIG. 1 are separated into a terminal device side and a server side. In this manner, the functions of the control/processing unit 2 may be shared by a plurality of computers.

In the cell observation apparatus of the above embodiment, the in-line type holographic microscope is used as the microscopic observation unit 1, but it is obvious that the in-line type holographic microscope may be replaced with another type of holographic microscope such as an off-axis type and a phase shift type as long as it is a microscope capable of obtaining a hologram.

Further, the above embodiment is an application of the present invention to the cell observation apparatus that displays the phase image obtained by the holographic microscope, but the same process can also be applied when displaying images showing a spatial distribution of a value corresponding to the phase value, for example, a pseudo phase value, an optical path length difference value and the like. Further, it goes without saying that the present invention may also apply to a cell observation apparatus for displaying a phase contrast microscopic image obtained by a phase contrast microscope.

Further, the above-described embodiments and the above-described modifications are merely examples of the present invention, and it goes without saying that further changes, modifications, and additions as appropriate within the scope of the gist of the present invention are encompassed within the scope of claims of the present invention.

1. A cell observation apparatus using a holographic microscope or a phase contrast microscope, comprising:
a) an image creation unit that creates an image showing a spatial distribution of phase information or information corresponding thereto on the basis of data obtained by the holographic microscope or the phase contrast microscope;
b) a drawing color setting unit that associates black with a phase value of zero, and gives a display color to each pixel on the image created by the image creation unit in accordance with a color scale associating a phase value which is a positive value and a phase value which is a negative value with different colors other than black respectively; and
c) a display processing unit that displays on a display unit an image with the display color given by the drawing color setting unit.

2. The cell observation apparatus according to claim 1, further comprising:
an adjustment operation unit that allows a user to adjust brightness and/or contrast of an image displayed on the display unit; and
an image parameter adjustment unit that adjusts the brightness and/or contrast of the image to be displayed, according to an operation by the adjustment operation unit.

3. The cell observation apparatus according to claim 1, further comprising a change operation unit that allows the user to change a correspondence between a range of the phase value in the color scale and the display color or its density,
wherein the drawing color setting unit changes the display color to be given to each pixel on the image according to an operation by the change operation unit.

4. The cell observation apparatus according to claim 1, wherein the drawing color setting unit gives the display color to each pixel on the image created by the image creating unit, in accordance with an arbitrary color scale selected from a plurality of previously prepared color scales in addition to the color scale.

5. The cell observation apparatus according to claim 1, further comprising a contrast adjustment unit that adjusts the contrast of the image automatically.
